(19) United States
(12) Patent Application Publication
(10) Pub. No.: US 2007/0064270 A1
(43) Pub. Date: Mar. 22, 2007

(54) Device managing apparatus, device management method, computer program product

(75) Inventor: Munemitsu Ikegami, Tokyo (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Ricoh Company, Ltd.

(21) Appl. No.: 11/520,199

(22) Filed: Sep. 12, 2006

(30) Foreign Application Priority Data
Sep. 16, 2005 (JP) 2005-270185

(51) Int. Cl. G06F 3/12

(52) U.S. Cl. 358/1.15

(57) ABSTRACT

A device managing apparatus that manages at least one device by communicating with the device. The device managing apparatus includes a processing unit that detects whether a pre-set setting for the device has been changed, and notifies that the pre-set setting has been changed to a predetermined device when detecting that the pre-set setting has been changed.

### PRIORITY

The present application claims priority to and incorporates by reference the entire contents of Japanese priority document, 2005-270185 filed in Japan on Sep. 16, 2005.

### BACKGROUND OF THE INVENTION

1. Field of the Invention

The present invention relates to a device managing apparatus that manages a plurality of devices arranged on a network, a device management method, and a computer program product.

2. Description of the Related Art

One example of a conventional device managing apparatus is a device management server that can collectively manage a plurality of devices arranged on a network. This device management server includes functions of displaying a list of the plurality of devices to be managed, and of setting predetermined functions with respect to the devices.

When a device manager wishes to manage a plurality of devices with a common setting, he registers the common setting as policy information with the device management server. The device management server regularly monitors the devices to be managed, and collects capabilities of each device (capability information and capability values).

Based on the policy information registered in the device management server and the capabilities of the devices, the device manager creates a setting value (device setting value) for each device and registers it in the device management server. For example, when policy information of “Wish to Setting B to ON” is registered beforehand, and he wishes to set a value as close as possible to this policy information, the closest setting value is “Setting B to ON”. However, if one of the devices does not have a Setting B, the setting value for that device becomes “Do not set Setting B”.

As another example, when there is a setting C that includes one value from among 1, 2, 3, and 4, policy information of “Wish to set setting C to 3” is stored beforehand, and the device manager wishes to set a value as close as possible to the policy information, the closest setting value is “Setting C to 3”. However, if one of the devices is such that “Setting C can only be set to 1 and 2”, the setting value for that device becomes “Set Setting C to 2”.

Thus, the device manager sets each individual device in the device management server, routinely sets the devices, or routinely sets all devices to be managed to register device setting values.

Alternatively, instead of the device manager, the device management server itself can automatically create and register device setting values such as those mentioned above for each device. Specifically, it automatically creates and registers device setting values that are closest to the policy information in consideration of the capabilities of the devices.

As one conventional device management technique, there is a remote monitoring system that performs remote monitoring by collecting information relating to a plurality of devices arranged on a network (Japanese Patent Application Laid-open No. 2002-297461).

In this type of conventional device management server, there is a possibility that a device setting made by the device management server can be changed unexpectedly by another manager due to, for example, a setting function of the device itself. When a device being managed is for some reason changed to a value that does not match its preset device setting value, it is preferable that the device management server detects the changed setting and returns it to the original setting status.

### SUMMARY OF THE INVENTION

A device managing apparatus, device management method and computer program product are described. In one embodiment, a device managing apparatus manages at least one device by communicating with the device, comprising: a processing unit that detects whether a pre-set setting for the device has been changed, and notifies that the pre-set setting has been changed to a predetermined device when detecting that the pre-set setting has been changed.

### DESCRIPTION OF THE DRAWINGS

FIG. 1 is a block diagram of a device management server according to an embodiment of the present invention;

FIG. 2A to 2D are tables indicating values in the embodiments; and

FIG. 3 is a flowchart of a process according to the embodiment.

### DETAILED DESCRIPTION OF THE PREFERRED EMBODIMENTS

Embodiments of the present invention at least partially solve the problems in the conventional technology.

According to an embodiment of the present invention, a device managing apparatus that manages at least one device by communicating with the device, includes a processing unit that detects whether a pre-set setting for the device has been changed and notifies that the pre-set setting has been changed to a predetermined device when detecting that the pre-set setting has been changed.

According to another embodiment of the present invention, a device management method performed by a device managing apparatus that manages at least one device by communicating with the device, includes detecting whether a pre-set setting for the device has been changed, and notifying that the pre-set setting has been changed to any one or more of the device and another device when detecting that the pre-set setting has been changed.

According to still another embodiment of the present invention, a computer program product comprising a computer usable medium having computer readable program codes embodied in the medium that when executed causes a computer to execute the above method.

The above and other embodiments, features, advantages and technical and industrial significance of this invention will be better understood by reading the following detailed description of presently preferred embodiments of the invention, when considered in connection with the accompanying drawings.

Exemplary embodiments of the present invention will be explained below in detail with reference to the accompanying drawings.

A device management server according to an embodiment of the device managing apparatus of the invention stores a device setting value indicating a setting status set by the device management server itself (or by a device manager, for example) in regard to a device being managed. Also, the device management server regularly monitors the devices, and collects device current values indicating a current setting status of each device at predetermined intervals. The device management server compares the device current value with the device setting value, and, when it detects a difference (value discrepancy) between them, it notifies the device manager that there is a device whose values differ by sending him an electronic mail (E-mail) or the like. By receiving this notification, the manager can reset the device whose values differ.

Alternatively, when the device management server detects a difference between a device current value and a device setting value, the device management server itself automatically returns the device whose values differ to its original setting, whereby the devices being managed can always be kept at a common setting.

When resetting a device being managed (for example, when the policy information of the device management server has been changed), the manager must identify which device requires resetting.

In the present embodiment, the device management server checks for discrepancies between the device setting value and the device current value of each device, and can display any discrepancy as a “Mismatch” in a list of the devices. Since this enables the manager to identify a mismatched device, he can easily reset it.

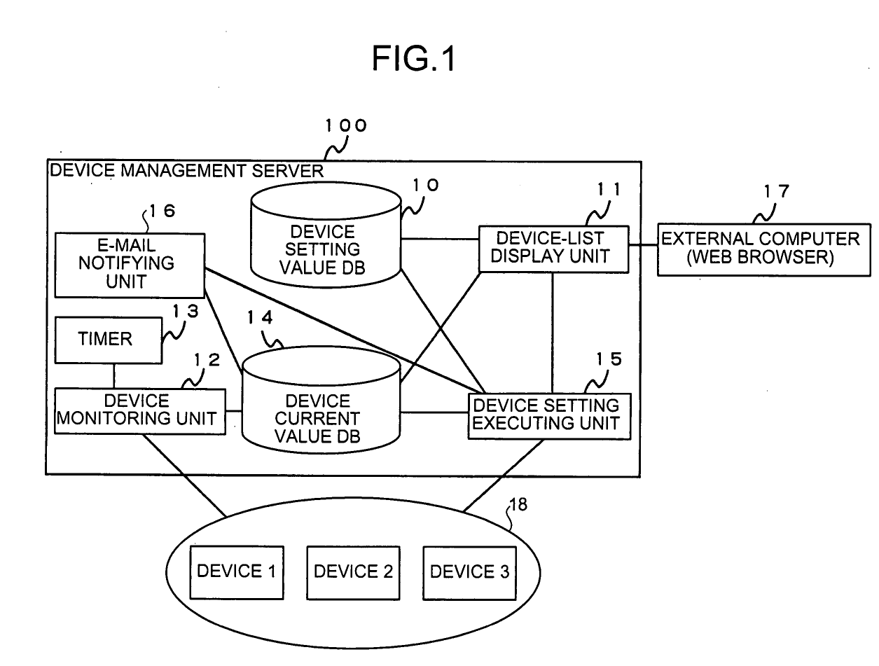

FIG. 1 is a block diagram of a configuration of a device management server 100 according to the present embodiment. As shown in FIG. 1, it is assumed in the present embodiment that a system includes the device management server 100, devices 1, 2, and 3 on a network 18 that can communicate with the device management server 100, and an external computer 17 that can communicate with the device management server 100. The configuration of the present embodiment is explained below with reference to FIG. 1.

A device-list display unit 11 includes a function of outputting device list information for displaying a list of devices to a terminal device and a display unit (display device) that are specified beforehand, such as the computer 17 that can communicate with the device management server 100 and a display device of the device management server 100.

A device monitoring unit 12 monitors the devices 1, 2, and 3 connected to the network at predetermined intervals, and obtains device current values indicating their current setting statuses from each device. The device current values are obtained using a conventional method such as simple network management protocol (SNMP) communication and communication by simple object access protocol (SOAP) messages via hypertext transfer protocol (HTTP). The device monitoring unit 12 is connected to a timer 13 for measuring the intervals.

A device setting value DB 10 is a database for storing policy information (system policies) and device capabilities, and for storing device setting values that are set based on the policy information and the device capabilities. As described above, the device setting values are created and registered automatically by the device management server itself, or created and registered by the device manager using an input unit (not shown). The device list information handled by the device-list display unit 11 is created based on managed information.

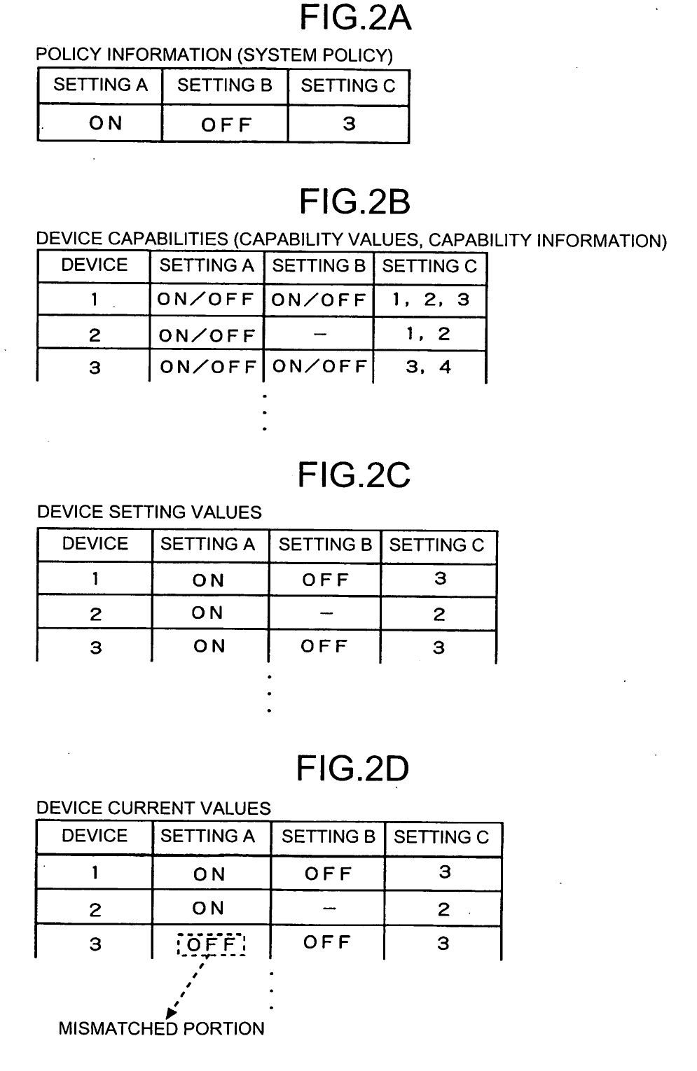

Policy information defines setting items and setting values for the devices 1, 2, and 3 that can be connected to the network. For example, in FIG. 2A, “Setting A, Setting B, Setting C” are the setting items for the device, and “ON, OFF, 3” are the setting values. These setting items and setting values are defined, and stored in the device setting value DB 10.

The device capability is a capability value (capability information) obtained from each device. For example, in FIG. 2B, setting items A and B in the device 1 can be switched ON/OFF, and a value of any one of 1 to 3 can be set for Setting C. For the device 2, while the setting item A can be switched ON/OFF, there is no value for Setting B, and a value of either 1 or 2 can be set for Setting C. For the device 3, setting items A and B can be switched ON/OFF, and a value of either 3 or 4 can be set for Setting C.

The device setting values are set based on the policy information shown in FIG. 2A and the device capabilities shown in FIG. 2B. As shown in FIG. 2C, values defined by the policy information, or values which approximates the policy information, are set.

A device current value DB 14 is a database for storing device current values that indicate current setting statuses of the devices 1, 2, and 3. The device current values are obtained by the device monitoring unit 12 at predetermined intervals. As shown in FIG. 2D, the forms of the device current values are the same as that of the device setting values of FIG. 2C.

A device setting executing unit 15 compares the device setting value stored in the device setting value DB 10 (see FIG. 2C) with the device current value stored in the device current value DB 14 (see FIG. 2D), and determines their sameness. The device setting executing unit 15 also includes functions of outputting commands to change the device current value to a new device setting value, and new device setting values.

An E-mail notifying unit 16 includes a function of issuing an E-mail to a terminal device whose address is registered beforehand, such as the external computer 17 and a cohabiting E-mail client, when a discrepancy between a device setting value and a device current value is detected. While the present embodiment uses E-mail, any type of mail is acceptable.

The devices 1, 2, and 3 communicate with the device management server 100 via the network, transmitting device capabilities and device current values, and receiving change command and new device setting values from the device management server 100. When the devices 1, 2, and 3 receive a command to change their device current values from the device management server 100, they automatically update to the new device setting value.

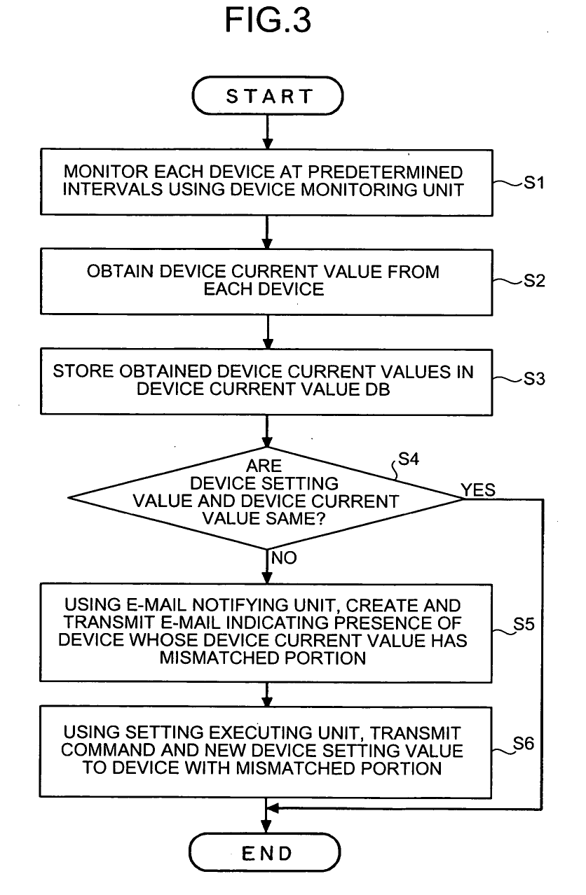

A process of the device management server 100 configured as described above will be explained with reference to FIG. 3. The device management server 100 of the present embodiment uses program control to execute a device management method shown in FIG. 3. A program of the present embodiment is incorporated beforehand in a predetermined storage region of the device management server, or is obtained by external communication, a recording medium, or the like.

It is assumed here that the device setting values of the devices 1, 2, and 3 are registered beforehand in the device setting value DB using the above method.

The device monitoring unit 12 monitors the devices 1, 2, and 3 based on predetermined intervals measured by the timer 13 (step S1). A device current value is obtained from each of the devices 1, 2, and 3 (step S2). The obtained device current values are stored in the device current value DB 14 (step S3). The device setting executing unit 15 compares the device setting values held in the device setting value DB 10 (see FIG. 2C) with the device current values stored in the device current value DB 14 (see FIG. 2D), and determines their sameness (step S4). If the result of this determination is that they are the same (step S4: Yes), processing ends. If the result of this determination is that they are not the same, that is, as shown in FIG. 2D, if any of the device current values is mismatched (step S4: No), the device setting executing unit 15 uses the E-mail notifying unit 16 to create an E-mail indicating that there is a device whose device current value has a mismatched portion and transmit the E-mail to a terminal of a device manager (step S5). To the device with the mismatched portion, the device setting executing unit 15 transmits a command ordering it to change its device current value to a new device setting value, and also transmits the new device setting value (step S6). The device that receives these automatically resets itself or is reset by the manager who receives the E-mail.

Thus, according to the present embodiment, even if a device setting value set beforehand at a device being managed has for some reason changed, the device management server can detect the change in the device setting value, and the changed setting can be returned to its original state.

In step S4, when there is a mismatched portion in the device current value (step S4: No), the device-list display unit 11 creates device list information that contains information indicating the device whose device current value has a mismatched portion, and outputs it to a predetermined terminal device or a display device and the like of the device management server. Therefore, according to the present embodiment, by displaying this device list information at a predetermined terminal device or a display device of the device management server, the device manager can identify the device with a mismatched portion and can easily reset it.

According to the present invention, when a pre-stored setting in a device to be managed is changed, it can be returned to its original status.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A device managing apparatus to manage at least one device by communicating with the device, comprising:
a processing unit to detect whether a pre-set setting for the device has been changed, and to notify that the pre-set setting has been changed to a predetermined device when detecting that the pre-set setting has been changed.

2. The device managing apparatus according to claim 1, wherein the processing unit includes
a device setting value storage unit to store therein a setting value indicative of the pre-set setting of the device;
a device current value collecting unit to collect a device current value indicative of a current setting status of the device from the device at predetermined intervals;
a mismatch determining unit to compare the device current value and the device setting value to determine whether there is a mismatch between two values;
a mismatch extracting unit to, when the mismatch determining unit determines that there is a mismatch, extract a difference between the two values; and
a notifying unit to notify the difference to the predetermined device.

3. The device managing apparatus according to claim 2, further comprising a device controller to control the device to correct the mismatch based on the difference.

4. The device managing apparatus according to claim 2, further comprising a device list information creating unit to create device list information for displaying a list of devices, and outputs the list to at least one of a predetermined device and a predetermined display unit, wherein
the device list information creating unit creates and outputs device list information that contains information indicating the device and a corresponding difference.

5. A device management method performed by a device managing apparatus that manages at least one device by communicating with the device, the device management method comprising:
detecting whether a pre-set setting for the device has been changed; and
notifying that the pre-set setting has been changed to any one or more of the device and another device when detecting that the pre-set setting has been changed.

6. The device management method according to claim 5, wherein the detecting includes
storing a setting value indicative of the pre-set setting of the device;
collecting a device current value indicative of a current setting status of the device from the device at predetermined intervals;
comparing the device current value and the device setting value to determine whether there is a mismatch between two values;
extracting, when it is determined at the determining that there is a mismatch, a difference between the two values; and
notifying the difference to the predetermined device.

7. The device management method according to claim 6, further comprising controlling the device to correct the mismatch based on the difference.

8. The device management method according to claim 6, further comprising creating device list information for displaying a list of the devices; and
outputting the list to at least one of a predetermined device or a predetermined display unit, wherein
creating the device list information includes creating and outputting device list information that contains information indicating the device and a corresponding difference.

9. A computer program product comprising a computer usable medium having computer readable program codes embodied in the medium that when executed causes a computer to execute a device management method on a device managing apparatus to manage at least one device by communicating with the device, the computer program causes the computer to:
detect whether a pre-set setting for the device has been changed; and
notify that the pre-set setting has been changed to any one or more of the device and another device when detecting that the pre-set setting has been changed.

10. The computer program product according to claim 9, wherein detecting whether the pre-set setting for the device has been changed includes
storing a setting value indicative of the pre-set setting of the device;
collecting a device current value indicative of a current setting status of the device from the device at predetermined intervals;
comparing the device current value and the device setting value to determine whether there is a mismatch between two values;
extracting, when it is determined at the determining that there is a mismatch, a difference between the two values; and
notifying the difference to the predetermined device.

11. The computer program product according to claim 10, further causing the computer to control the device to correct the mismatch based on the difference.

12. The computer program product according to claim 10, further causing the computer to create device list information for displaying a list of the devices; and
output the list to at least one of a predetermined device or a predetermined display unit, wherein
creating includes creating and outputting device list information that contains information indicating the device and a corresponding difference.
